(19) United States
(12) Patent Application Publication
(10) Pub. No.: US 2018/0121715 A1
(43) Pub. Date: May 3, 2018

(54) METHOD AND SYSTEM FOR PROVIDING FEEDBACK UI SERVICE OF FACE RECOGNITION-BASED APPLICATION

(71) Applicant: Korea Advanced Institute of Science and Technology, Daejeon (KR)

(72) Inventors: Woon Tack WOO, Daejeon (KR); Jeonghun JO, Daejeon (KR); Sung Sil KIM, Daejeon (KR); Young Kyoon JANG, Daejeon (KR)

(21) Appl. No.: 15/563,448

(22) PCT Filed: Jun. 18, 2015
(86) PCT No.: PCT/KR2015/006181

§ 371 Date: Sep. 29, 2017

(30) Foreign Application Priority Data
Apr. 2, 2015 (KR) 10-2015-0046990

(51) Int. Cl. G06K 9/00; H04M 1/725; G06F 21/32; G06Q 50/00

(52) U.S. Cl. CPC G06K 9/00302; G06Q 50/01; G06F 21/32; H04M 1/72544

(57) ABSTRACT

The present invention includes the steps of: displaying an unlocking interface via a user interrupt; receiving an unlocking pattern inputted via the unlocking interface; detecting the received unlocking pattern and executing a mode corresponding to the detected unlocking pattern to thereby measure the status degree of an object corresponding to the detected unlocking pattern; and calling a lookup table in which a range of adequate status degrees for each type is measured and matched according to a pre-set and classified object type to thereby determine the status degree of the measured object, and feeding back the result of the determination via the unlocking interface.

### TECHNICAL FIELD

The present invention relates to a feedback UI of a facial expression recognition based smile inducing application.

### BACKGROUND ART

Recently, as artificial intelligence and pattern recognition technologies have been developed, facial expression recognition is one of the important technologies in a human computer interface (HCI) and many researches related thereto have been carried out, and technical researches related to facial expression diagnosis through the facial expression recognition have been made [1, 2], however, there is a lack of interaction design considering practical use, and as a result, commercialization of a program using the interaction design is also unknown.

In addition, a technique for diagnosing human emotions by minutely measuring human facial expressions is studied [3]. The technique is continuously developed as the technique may help interaction by determining understanding and interest through emotions expressed by facial expressions [4].

In this regard, Korean Patent Unexamined Publication No. 2013-0082980 (published on Jul. 22, 2013) discloses a method that recognizes a face of a user, generates identification information for identifying the face, stores the generated identification information for each user in a DB and thereafter, determines whether the face of the user who tries unlocking is present in the DB to perform a customized recommendation service for a verified user through prestored information.

In the prior art documents, since only fixed services are performed based on an initially stored fixed user face, adaptive services based on varying facial expressions are impossible.

In addition, a technique for a user to diagnose the facial expression of himself/herself is studied [5]. In existing studies, only the degree of smile is measured and smile training or an effective design method for inducing the smile is not discussed, and as a result, a question remains in practicality.

### DETAILED DESCRIPTION OF THE INVENTION

### Technical Problem

Accordingly, the present invention has been made in an effort to provide a medium application technique of self-facial expression, which enables feedback depending on a change in emotion of a user by determining the degree of a smile of a user and feeding back a UI configured and specialized according to a smile type and a level range to the user to diagnose sensitivity of the user and is high in accessibility of the user and is capable of checking the user himself/herself through an emotion based interaction mechanism by determining understanding and interest through an emotion shown through facial expression and recommending articles, applications, travel destinations, famous restaurants, etc.

### Technical Solution

According to an aspect of the present invention, a method for providing a feedback UI service of a face recognition-based application includes: displaying an unlocking interface via a user interrupt; receiving an unlocking pattern inputted via the unlocking interface; detecting the received unlocking pattern and executing a mode corresponding to the detected unlocking pattern to thereby measure the status degree of an object corresponding to the detected unlocking pattern; and calling a lookup table in which a range of adequate status degrees for each type is measured and matched according to a pre-set and classified object type to thereby determine the measured status degree of the object, and feeding back the result of the determination via the unlocking interface.

According to another aspect of the present invention, an apparatus for providing a feedback UI service of a face recognition-based application includes: a camera unit acquiring an image including a face of a user; a touch screen displaying an unlocking interface through a user interrupt and outputting an unlocking pattern inputted through the unlocking interface; and a control unit detecting the unlocking pattern output from the touch screen and executing a mode corresponding to the detected unlocking pattern, measuring a status degree of an object corresponding to the detected unlocking pattern, determining the measured status degree of the object by calling a lookup table matched by measuring an appropriate status degree range for each type according to a pre-set and classified object type, and controlling a determination result to be fed back through the unlocking interface.

### Advantageous Effects

According to the present invention, a medium application of self-facial expression can be provided, which enables feedback depending on a change in emotion of a user to diagnose sensitivity of the user and is high in accessibility of the user and is capable of checking the user himself/herself through an emotion based interaction mechanism by determining understanding and interest through an emotion shown through facial expression and recommending articles, applications, travel destinations, famous restaurants, etc.

### DESCRIPTION OF THE DRAWINGS

FIG. 1 is an overall flowchart of a method for providing a feedback UI providing service of a face recognition-based application according to an embodiment of the present invention.

FIG. 2 is a detailed flowchart illustrating an operation of a mode corresponding to an unlocking pattern in the method for providing a feedback UI service of a face recognition-based application according to the embodiment of the present invention.

FIG. 3A is a diagram showing an exemplary implementation of a predetermined feedback UI prototype for each object type in the method for providing a feedback UI service of a face recognition-based application according to the embodiment of the present invention.

FIG. 3B is a diagram showing another exemplary implementation of a predetermined feedback UI prototype for each object type in the method for providing a feedback UI service of a face recognition-based application according to the embodiment of the present invention.

FIG. 3C is a diagram showing yet another exemplary implementation of a predetermined feedback UI prototype for each object type in the method for providing a feedback UI service of a face recognition-based application according to the embodiment of the present invention.

FIG. 4 is a detailed block diagram of an apparatus for providing a feedback UI service of a face recognition-based application according to an embodiment of the present invention.

### MODE OF THE INVENTION

Hereinafter, preferred embodiments of the present invention will be described in detail with reference to the accompanying drawings. It will be apparent to those skilled in the art that specific matters such as a detailed constituent element, and the like are shown and just provided in order to help more overall appreciation of the present invention and predetermined modifications or changes of specific matters can be made in the present invention without departing from the scope of the invention.

The present invention relates to a feedback UI of a facial expression recognition-based smile inducing application, and more particularly, the present invention has been made in an effort to provide a medium application technique of self-facial expression, which enables feedback depending on a change in emotion of a user by detecting an unlocking pattern input through the unlocking interface on a screen on which a shortcut unlocking interface for making a terminal with a touch screen be an operating status after entering a screen locking status is displayed, verifying that the detected unlocking pattern is a pre-set pattern and thereafter, determining a status degree of an object corresponding to the verified pattern through a lookup table and feeding back a UI configured and specialized according to an object related type and a level range to diagnose sensitivity of the user and is high in accessibility of the user and check the user himself/herself through an emotion based interaction mechanism by determining understanding and interest through an emotion shown through facial expression and recommending articles, applications, travel destinations, famous restaurants, etc.

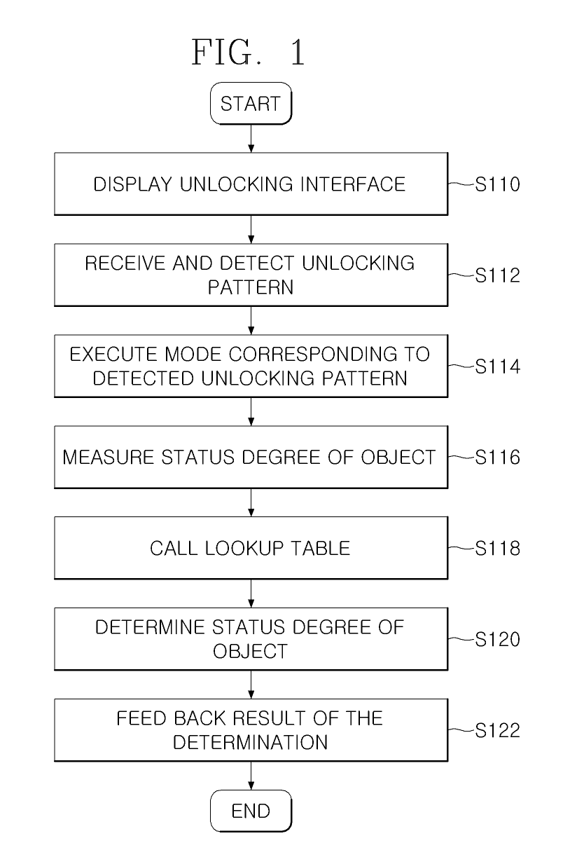

Hereinafter, a method for providing a feedback UI service of a face recognition-based application according to an embodiment of the present invention will be described in detail with reference to FIGS. 1 to 3.

First, FIG. 1 is an overall flowchart of a method for providing a feedback UI service of a face recognition-based application according to an embodiment of the present invention.

Referring to FIG. 1, first, in process 110, an unlocking interface is displayed on an initial screen of a terminal having an unlocking function via a user interrupt and in process 112, and an unlocking pattern inputted through the unlocking interface is received to detect the received unlocking pattern.

In this case, the unlocking interface on the initial screen means forming a locking means, that is, a lock application. As the locking means, a type that releases the lock by inputting a numeric password within a pre-set time or a type that releases the lock by a method that inputs a pattern is pre-set from a user and selected and used. In addition, various types of patterns such as images, texts, and voices may be selected and used as the method for inputting the pattern and the pattern inputting method is classified into feature extraction and pattern matching parts for each type and recognized. According to the present invention, a face inputted through a camera is recognized, and it is determined whether the recognized face matches a pre-set pattern in the unlocking pattern. When the recognized face matches the pre-set pattern, the screen is unlocked to provide an execution screen.

In addition, the unlocking interface has a plurality of divided areas, and corresponding items are formed in the respective divided areas, and a first menu providing a first service related to the item is pre-set in a first position in the divided area and a second menu related to the item formed in the divided area and providing a second service different from the first service is pre-set in a second position different from the first position.

The first menu, which is a service in which a feedback UI for each object type is provided, is pre-set in the first position and the second menu, which is a service in which a message associated with the feedback UI displayed in the first position is displayed in a predetermined frame is pre-set in the second position.

In process 114, a mode corresponding to the detected unlocking pattern is executed and a status degree of an object corresponding to the detected unlocking pattern is measured in process 116.

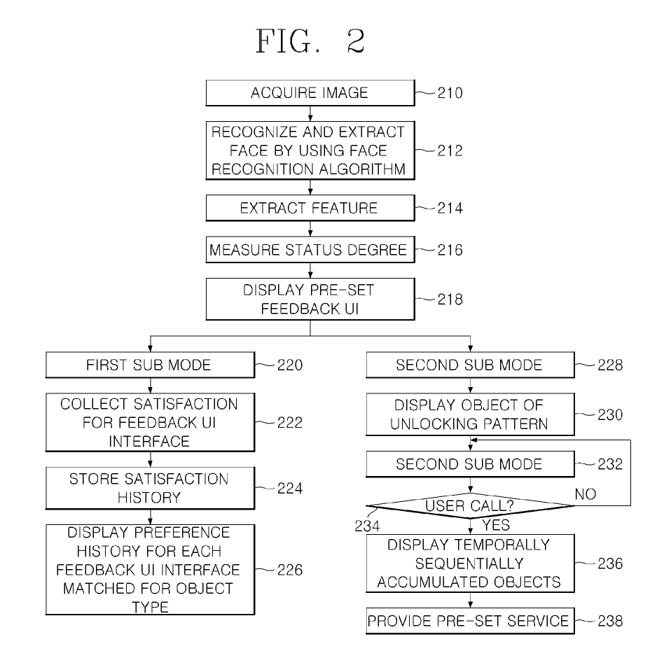

Herein, the mode corresponding to the unlocking pattern is a mode for performing a feedback UI providing service operation of the face recognition based application according to an embodiment of the present invention and specifically, the operation of the mode will be described in detail by operational description of FIG. 2 to be described below.

Subsequently, in process 118, an appropriate status degree range for each type is measured according to a pre-set and classified object type to call a matched lookup table and in process 120, the measured status degree of the object is determined through the called lookup table.

The object type pre-set and classified in process 118 is defined and classified by considering a context of use in order to design a feedback method that induces a smile to the user and includes a target type that requires smile training or desires instant facial expression management, a motivation type that requires a change of mind in a situation in which there is an intention to smile but the user may not smile, and a passive type in which the user has a will to smile by getting a stimulus even when the user does not intend to smile.

The feedback corresponding to the target type provides numerical information of the smile to accurately evaluate the smile.

The feedback corresponding to the motivation type provides consolation and empathy messages for natural laughing motivation formation.

The feedback corresponding to the passive type grants the smile will to images that visualize the user's facial expression.

In process 122, the determination result in process 120 is fed back through the unlocking interface.

Herein, in the case of the feedback, as feedback UIs which are differently displayed through the unlocking interface are pre-set for each type of the object, the corresponding feedback UI matches the measured status degree according to the type pre-set in the mode and is displayed.

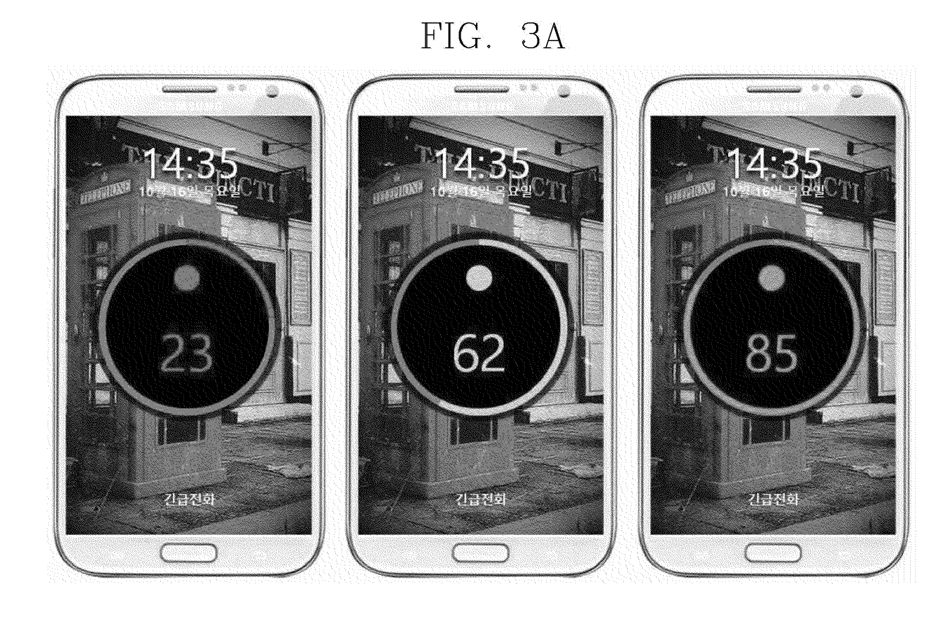

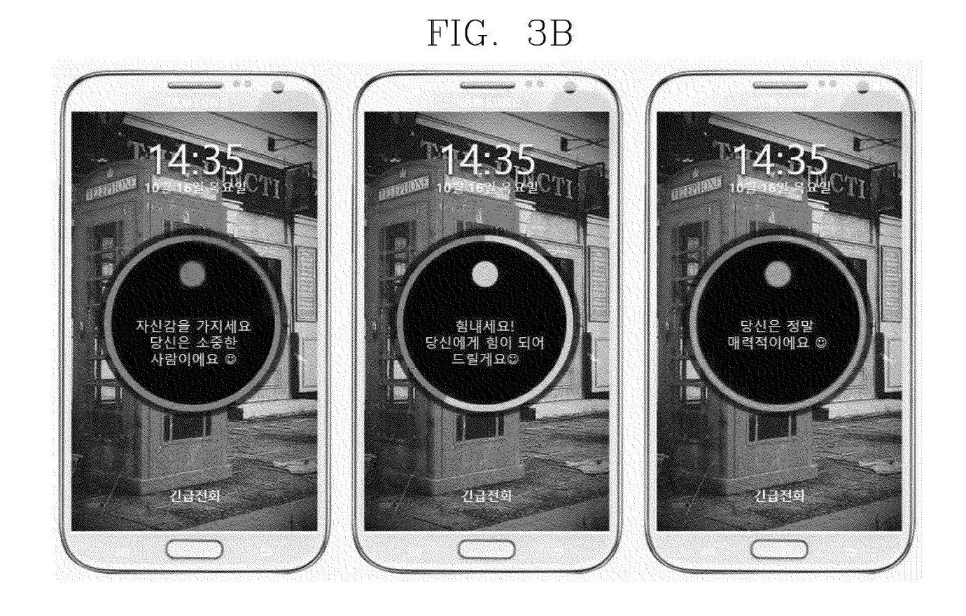

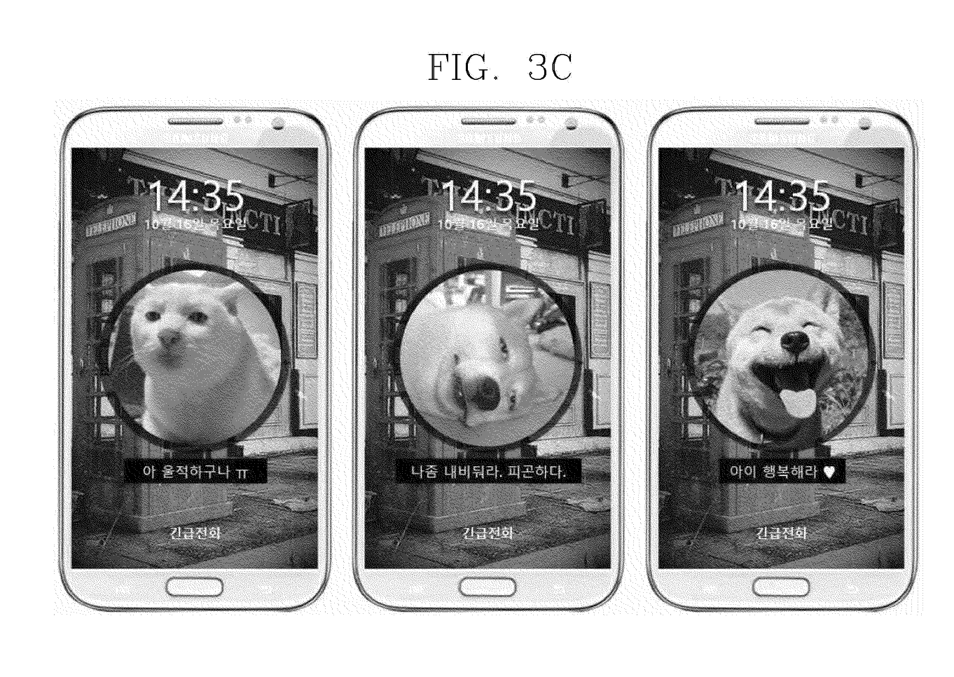

For example, when the type set in the mode is the target type, the status degree of the object corresponding to the target type is quantified and visualized, classified according to the level to check the feedback UI pre-set and matched for each level through the tabulated lookup table and guide the checked feedback UI to the user through the unlocking interface as illustrated in FIG. 3A.

In the present invention, the feedback UI is classified for each type of the object and describes a feedback UI method suitable for a locking screen according to each smile-inducing feedback method.

In this case, the feedback UI includes a target type feedback UI that visualizes and quantifies, and displays the status degree of the object with a circular graph, a motivation type feedback UI that visualizes the status degree of the object with the circular graph or outputs a message pre-set and matched for each status degree, and a passive type feedback UI that associates a pre-registered image corresponding to the status degree of the unlocking pattern and the image related message and displays the associated images in a predetermined frame.

In this case, the circular graph is displayed at the center of the area where the unlocking interface is displayed as illustrated in each of FIGS. 3a) and 3b) and numerals acquired by quantifying status degree are colored and displayed differently from each other according to the status degree.

Herein, referring to FIG. 3A˜3C, FIG. 3A˜3C relate to a pre-set feedback UI prototype for each object type in the method for providing a feedback UI service of a face recognition-based application according to the embodiment of the present invention and FIG. 3A relates to a quantitative quantification (target type) visualizing the smile degree and showing numerals with the circular graph and colors of graphs and numbers are displayed in the order of red-yellow-green according to the smile degree of the user from left to right.

FIG. 3B relates to a motivation inducing message (motivation type) visualizing the smile degree with the circular graph and showing messages of the consolation and sympathy without a numerical value and a predetermined message is shown according to the smile degree to arouse the sympathy of the user. The colors of the graph and the number are displayed in the order of red-yellow-green according to the smile degree of the user.

FIG. 3C illustrates images and assistant mentions most similar to the user's facial expression in a circular frame without the graph or numerical expression and herein, as the image, an animal image, a celebrity image, and the like are used.

As described above, the method for providing a feedback UI service of the face recognition-based application according to the embodiment of the present invention measures the degree of the smile by recognizing the facial expression at the same time when the terminal is unlocked, sets a type and feedback UI type based feedback scheme according to user selection based on the measured result, and feeds back the degree of the smile by quantification, that is, a scoring scheme or message scheme, or shaping scheme to provide a feedback UI of the smile inducing application.

Subsequently, FIG. 2 is a detailed flowchart illustrating an operation of a mode corresponding to the unlocking pattern in the method for providing a feedback UI service of a face recognition-based application according to the embodiment of the present invention.

Referring to FIG. 2, in process 210, an image including the face of the user is acquired at a predetermined distance through a camera provided in the terminal according to the present invention.

The acquired image is divided into frames having pre-set different frame numbers.

Herein, the pre-set distance means a distance in which the facial expression may be recognized in the embodiment of the present invention and the pre-set number of frames represents allocation of a frame that is used for generation of a face image for each pre-set distance, but the present invention is not limited thereto. Respective divided frames having different numbers of frames within a pre-set distance are obtained from an actual image photographed at the pre-set distance for automatic generation of the facial image.

In process 212, the face is recognized and extracted from the image for each of the divided frames by using a face recognition algorithm.

Herein, the face recognition algorithm as a technique that recognizes the face through positional recognition of a contour, eyes, a jaw, and a mouth of the face in an entire image space may adopt various known methods for detecting a face region corresponding to faces of the user from the acquired face image. For example, there are a method that recognizes the face as geometric features such as sizes and positions of the eye, a nose, the mouth, and the like which are components of the face and a method that recognizes a statistical value of the entire face as a feature, such as principal component analysis (PCA) and linear discriminant analysis (LDA) of the entire face.

In process 214, a pre-set feature for determining the object status degree is extracted from the extracted face image and in process 216, the status degree of the corresponding object is measured from the extracted feature and in process 218, a pre-set feedback UI is displayed.

In this case, the object is a smile facial expression in which the smile degree may be measured and the status degree is generated by measuring and leveling a smile amount corresponding to the smile facial expression.

The pre-set feature is used for measuring the smile degree by recognizing the facial expression by using facial muscle motion information and a predetermined position of the face is pre-set as the feature based on the face image registered from the user and the status degree of the object is measured by estimating motion information of a position in a currently inputted image corresponding to the set feature. For example, when features of a middle of the forehead concentrate on the center, in the case where features granted to the inside of an eyebrow go downward or features granted to both ends of a lip go down, it is determined that the feature is changed.

Thereafter, in the present invention, the mode is switched to a first or second sub mode according to a sub mode set in the mode corresponding to the unlocking pattern to perform an operation depending on the sub mode.

More specifically, when the mode is switched to the first sub mode in process 220, in process 222, satisfaction of the user for each corresponding feedback UI is collected through the interface which is unlocked after the feedback service is performed.

The satisfaction is collected through a separate window in the execution screen which is unlocked and the satisfaction of a status degree related feedback UI corresponding to the unlocking pattern for the unlocking for each pre-set period or for each unlocking occurrence is collected and stored and transmitted to a serving service server interlocked through a network.

In this case, the serving service server additionally stores and manages a history for a preference for each feedback UI by collecting the satisfaction of the corresponding user for each feedback UI matched for each type of the object through the operation of process 224.

In process 226, the preference history for each UI matched for each object type requested from the terminal is displayed through the network and a user reputation is simultaneously displayed based on the history for each feedback UI at an initial stage of the execution screen and the feedback UI which induces the smile is selected and adaptively set in the mode with reference to the displayed user reputation.

Meanwhile, in process 228, the mode is switched to the second sub mode and the subsequent operation is performed. In process 230, the detected object of the unlocking pattern is displayed through the interface which is unlocked, that is, a separate window of the execution screen.

In process 232, the displayed object is stored together with corresponding time information.

Whether the user is called is checked through the operation in process 234 and when the user is called, the process proceeds to process 236 and temporally sequentially accumulated objects are displayed.

In process 238, a pre-set service is provided according to the status degree corresponding to the object for each time.

In this case, the pre-set service recommends a service interlocked through a social networking service (SNS) server associated based on numerical data output for each status degree corresponding to the object and through the recommended service and through the recommended service, in the method for providing a feedback UI service of a face recognition-based application according to the embodiment of the present invention, since things required for the user are recommended through face recognition based status degree data of the smile measured at the time same as the unlocking of the terminal, the user's accessibility is high and since the smile is frequently measured, it is useful for the user to check the user himself/herself.

Hereinabove, the method for providing a feedback UI service of a face recognition-based application according to the embodiment of the present invention has been described.

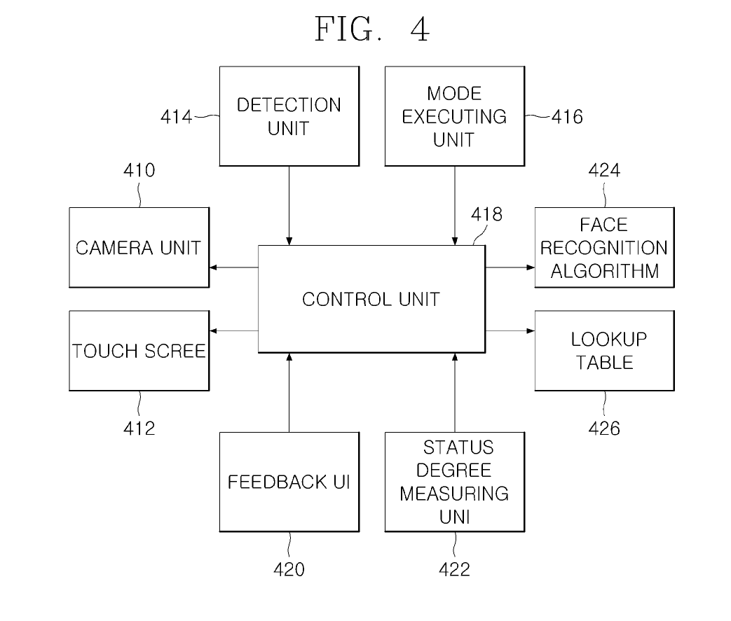

Hereinafter, an apparatus for providing a feedback UI service of a face recognition-based application according to an embodiment of the present invention will be described in detail with reference to FIG. 4.

FIG. 4 is a detailed block diagram of an apparatus for providing a feedback UI service of a face recognition-based application according to an embodiment of the present invention.

Referring to FIG. 4, the apparatus according to the present invention includes a camera unit 410, a touch screen 412, a detection unit 414, a mode executing unit 416, a control unit 418, a feedback UI 420, a status degree measuring unit 422, a face recognition algorithm 424, and a lookup table 426.

The camera unit 410 acquires an image including a face of a user.

The touch screen 412 displays an overall operation execution screen of the apparatus according to the present invention and receives data generated from the user. Further, the touch screen 412 displays an unlocking interface through a user interrupt and outputs an unlocking pattern inputted through the unlocking interface.

The control unit 418 detects the unlocking pattern output from the touch screen 412 through the detection unit 414 and executes a mode corresponding to the detected unlocking pattern by controlling the mode executing unit 416.

Further, the control unit 418 measures a status degree of an object corresponding to the detected unlocking pattern through the status degree measuring unit 422, determines the measured status degree of the object by calling a lookup table 426 matched by measuring an appropriate status degree range for each type according to a pre-set and classified object type, and controls a determination result so as to feed back a corresponding feedback UI through the unlocking interface.

In this case, the pre-set and classified object type includes a target type that requires smile training or desires instant facial expression management, a motivation type that requires a change of mind in a situation in which there is an intention to smile but the user may not smile, and a passive type in which the user has a will to smile by getting a stimulus even when the user does not intend to smile.

In addition, the control unit 418 matches, as the feedback is displayed as feedback UIs which are differently displayed through the unlocking interface are pre-set for each type of the object, the corresponding feedback UI with the measured status degree according to the type set in the mode, displays the corresponding feedback UI and feeds back the displayed feedback UI through the touch screen 412.

Herein, the feedback UI includes a target type feedback UI that visualizes and quantifies, and displays the status degree of the object with a circular graph, a motivation type feedback UI that visualizes the status degree of the object with the circular graph or outputs a message pre-set and matched for each status degree, and a passive type feedback UI that associates a pre-registered image corresponding to the status degree of the unlocking pattern and the image related message and displays the associated images in a predetermined frame.

The circular graph is displayed in a region in which the unlocking interface is displayed and numbers in which a status degree is quantified are colored and displayed differently according to the status degree.

The mode executing unit 416 executes the corresponding mode by switching the mode under the control of the control unit 418, acquires an image including a face of the user at a pre-set distance through the camera unit 410, recognizes and extracts the face by using a pre-set face recognition algorithm 424 and extracts a pre-set feature to determine an object status degree from the extracted face image, and executes a mode in which the status degree of the corresponding object is measured from the extracted feature.

As described above, the operations related with the method and the apparatus for providing a feedback UI service of a face recognition-based application according to the present invention may be performed and meanwhile, in describing the present invention, a detailed embodiment is described, but various modifications can be made without departing from the scope of the present invention. Accordingly, the scope of the present invention should not be defined by the embodiment, but defined by the claims and equivalents thereto.

1. A method for providing a feedback UI service of a face recognition-based application, the method comprising:
displaying an unlocking interface via a user interrupt;
receiving an unlocking pattern inputted via the unlocking interface;
detecting the received unlocking pattern and executing a mode corresponding to the detected unlocking pattern to thereby measure the status degree of an object corresponding to the detected unlocking pattern; and
calling a lookup table in which a range of adequate status degrees for each type is measured and matched according to a pre-set and classified object type to thereby determine the status degree of the measured object, and feeding back the result of the determination via the unlocking interface.

2. The method of claim 1, wherein the pre-set and classified object type includes
a target type that requires smile training or desires instant facial expression management,
a motivation type that requires a change of mind in a situation in which there is an intention to smile but the user may not smile, and
a passive type in which the user has a will to smile by getting a stimulus even when the user does not intend to smile.

3. The method of claim 1, wherein the mode corresponding to the unlocking pattern includes
acquiring an image including a face of the user at a predetermined distance through a camera,
recognizing and extracting the face by using a pre-set face recognition algorithm,
extracting a pre-set feature for determining the object status degree from the extracted face image, and
measuring the status degree of the corresponding object from the extracted feature.

4. The method of claim 1, wherein in the feedback process, as feedback UIs which are differently displayed through the unlocking interface are pre-set for each type of the object, the corresponding feedback UI matches the measured status degree according to the type set in the mode and is displayed.

5. The method of claim 4, wherein the feedback UI includes
a target type feedback UI that visualizes and quantifies, and displays the status degree of the object with a circular graph,
a motivation type feedback UI that visualizes the status degree of the object with the circular graph or outputs a message pre-set and matched for each status degree, and
a passive type feedback UI that associates a pre-registered image corresponding to the status degree of the unlocking pattern and the image related message and displays the associated images in a predetermined frame.

6. The method of claim 5, wherein the circular graph is displayed in a region in which the unlocking interface is displayed and numbers in which a status degree is quantified are colored and displayed differently according to the status degree.

7. The method of claim 1, wherein the unlocking interface has a plurality of divided areas, and corresponding items are formed in the respective divided areas, and a first menu providing a first service related to the item is pre-set in a first position in the divided area and a second menu related to the item formed in the divided area and providing a second service different from the first service is pre-set in a second position different from the first position.

8. The method of claim 1, wherein the object is a smile facial expression and the status degree is generated by measuring and leveling a smile amount corresponding to the smile facial expression.

9. The method of claim 1, wherein the mode corresponding to the unlocking pattern includes
a first sub mode to additionally store and manage a satisfaction history for the feedback UI by collecting satisfaction of the user for each corresponding feedback UI through the unlocked interface after performing the feedback service and display a preference history for each feedback UI matched for each object type upon a user request, and
a second sub mode to display the detected object of the unlocking pattern through the unlocked interface, store the displayed object together with corresponding time information and display temporally sequentially accumulated objects upon a user call, and provide a pre-set service according to the status degree corresponding to the object for each time.

10. The method of claim 9, wherein the pre-set service recommends a service interlocked through a social networking service (SNS) service server associated based on numerical data output for each status degree corresponding to the object.

11. An apparatus for providing a feedback UI service of a face recognition-based application, the apparatus comprising:
a camera unit acquiring an image including a face of a user;
a touch screen displaying an unlocking interface through a user interrupt and outputting an unlocking pattern inputted through the unlocking interface; and
a control unit detecting the unlocking pattern output from the touch screen and executing a mode corresponding to the detected unlocking pattern, measuring a status degree of an object corresponding to the detected unlocking pattern, determining the measured status degree of the object by calling a lookup table matched by measuring an appropriate status degree range for each type according to a pre-set classified object type, and controlling a determination result to be fed back through the unlocking interface.

12. The apparatus of claim 11, wherein the pre-set classified object type includes
a target type that requires smile training or desires instant facial expression management,
a motivation type that requires a change of mind in a situation in which there is an intention to smile but the user may not smile, and
a passive type in which the user has a will to smile by getting a stimulus even when the user does not intend to smile.

13. The apparatus of claim 11, further comprising:
a mode executing unit switching a mode under the control of the control unit and executing the corresponding mode,
wherein the mode executing unit acquires an image including a face of the user at a pre-set distance through the camera unit, recognizes and extracts the face by using a pre-set face recognition algorithm and extracts a pre-set feature to determine an object status degree from the extracted face image, and executes a mode in which the status degree of the corresponding object is measured from the extracted feature.

14. The apparatus of claim 11, wherein the control unit matches, as feedback UIs which are differently displayed through the unlocking interface are pre-set for each type of the object, the corresponding feedback UI with the measured status degree and displays and feeds back the corresponding feedback UI.

15. The apparatus of claim 14, wherein the feedback UI includes
a target type feedback UI that visualizes and quantifies, and displays the status degree of the object with a circular graph,
a motivation type feedback UI that visualizes the status degree of the object with the circular graph or outputs a message pre-set and matched for each status degree, and
a passive type feedback UI that associates a pre-registered image corresponding to the status degree of the unlocking pattern and the image related message and displays the associated images in a predetermined frame.

16. The apparatus of claim 15, wherein the circular graph is displayed in a region in which the unlocking interface is displayed and numbers in which a status degree is quantified are colored and displayed differently according to the status degree.
